(19) United States
(12) Patent Application Publication
(10) Pub. No.: US 2015/0178007 A1
(43) Pub. Date: Jun. 25, 2015

(54) METHOD AND SYSTEM FOR INTEGRATED CLOUD STORAGE MANAGEMENT

(71) Applicant: Cloudifyd, Inc., New York, NY (US)

(72) Inventors: Adam Moisa, New York, NY (US); Matías Alejandro Dumrauf, Buenos Aires (AR); Ronan Yoel Weinberg Waks, New York, NY (US)

(21) Appl. No.: 14/635,057

(22) Filed: Mar. 2, 2015

Related U.S. Application Data
(63) Continuation-in-part of application No. 13/839,793, filed on Mar. 15, 2013.
(60) Provisional application No. 62/000,738, filed on May 20, 2014.
(60) Provisional application No. 62/054,706, filed on Sep. 24, 2014.

(51) Int. Cl. G06F 3/06; H04L 9/32; G06F 17/30

(52) U.S. Cl. CPC G06F 3/0622; G06F 3/0644; G06F 3/067; G06F 17/30112; H04L 9/3263

(57) ABSTRACT

A system and method for storing and retrieving files across multiple cloud storages, including the steps of splitting a file into a plurality of chunks, sending a first chunk to a first storage with a first instruction particular to the first storage and sending a second chunk to a second storage with a second instruction particular to the second storage, where the first and second instructions are different from each other.

### CROSS-REFERENCE TO RELATED APPLICATIONS

This application is a continuation-in-part of U.S. application Ser. No. 13/839,793 filed Mar. 15, 2013 and further claims the benefit of U.S. Provisional Patent Application No. 62/000,738 filed May 20, 2014, and Provisional Patent Application No. 62/054,706, filed Sep. 24, 2014, all of which are incorporated by reference herein in their entirety.

### FIELD OF THE INVENTION

The present disclosure relates to methods and systems for integrated cloud storage management. In particular, the present disclosure relates to storage and security of files in multiple storage systems while accessing those storage systems from a single user environment.

### BACKGROUND

Cloud-based storage allows a user access to files regardless of the location of a computer, and offers a convenient means of sharing, backing up, or using files. With many different companies offering cloud storage services, the consumer has a wide choice of options for where to store files. Many suppliers offer some limited amount of storage free of charge, or provide entry level pricing for minimal storage or features. Because of the availability of size or feature limited accounts, users tend to open more than one storage account with either the same storage provider or different storage providers in order to store more data or use varied features.

Varied special features associated with these accounts, such as editing features associated with specific file types or sharing features as well as special account opening promotions lead users to open additional accounts with additional providers. Managing such a variety of accounts can be tedious for users.

The use of multiple accounts creates usability challenges. Files end up scattered across multiple cloud storage accounts and companies, and it may become difficult to track and manage files across multiple accounts. Further, it may be difficult to transfer files from one account to another in order to take advantage of features associated with a specific platform, transfer to a different user using a different platform, or search across all platforms.

With only a limited capacity available in each cloud storage account, files that are larger than the current capacity of a storage account cannot be saved, and it may be difficult to manipulate files across different accounts to create space. In some situations, a file to be stored may be larger than the account space in any single cloud storage account, preventing the user from saving the file on any single account.

Further, with users storing their potentially sensitive data in third party systems, the different storage systems may have inadequate security measures in place. It is particularly difficult to maintain adequate security when files are stored on a variety of platforms, and users may wish to implement a security system independent of those provided by the platforms.

There is a need for systems and methods for organizing stored files across multiple cloud storage accounts while efficiently using multiple storage systems simultaneously and seamlessly. There is a further need for systems and methods that can take advantage of special features associated with individual storage systems, as well as a need for security features independent of the storage systems themselves.

### SUMMARY

The present disclosure is directed to a method and system for integrated cloud storage management. In particular, the disclosure is directed towards the storage and securing of files in multiple storages while accessing the files from a single access point. A method for storing data, such as a file, according to a preferred embodiment, includes splitting a file into a plurality of chunks, sending one of the chunks to a first storage, such as a first cloud storage service with instructions particular to the first storage, and sending a second chunk to a second storage, such as a different cloud storage service, with instructions particular to the second storage. Each chunk may be independently encrypted prior to transmitting the chunks to storage. This may be in addition to, or in lieu of, encrypting the entire file using a similar or distinct encryption methodology.

Typically, the first instruction and the second instruction are different from each other, as they each correspond to different storages. The chunks utilized by the method may be different sizes, with each chunk corresponding to a chunk breakup multiple.

The data stored may be in the form of a file and may represent a file folder or some other data abstraction. In some embodiments, the method first places the file into a buffer storage, which may be a third cloud storage service, prior to splitting the file.

The splitting of the file may be performed by worker modules in a worker pool.

Information about the files and/or the chunks comprising the files may be independently stored. This information may include metadata from the file, as well as storage locations of the individual chunks of the file. The collection of information may be packaged such that it may be treated as a file in its own right, and when accessed it may access the individual chunks associated with the file by utilizing the information stored therein.

In some embodiments, metadata may be stripped from the chunks themselves, or never applied to the chunks, such that the metadata associated with the chunks are stored only within the index.

A search command initiated within the system may search only the metadata associated with the files and/or the chunks, and may not search the storages where files are stored.

In some embodiments, at regular intervals, chunks may be moved from a storage in which they were previously placed to new storage locations, and the information related to their storage locations in the index may be updated as well. In moving a chunk, the system and method may transmit instructions to the storage in which the chunk currently resides such that those instructions are understood by that storage system, to transmit the chunk to a different storage system. The system and method may further transmit instructions to be understood by the different storage system governing the storage of the chunk in the new location. At the same time, the system and method may receive from the storage systems information about the new storage location of the chunk, and may use that information to update the index.

In some embodiments, the chunks are encrypted and the overall file is not, such that file chunks may be transported to buffer storage and accessed consecutively without placing the entire file in one place.

The buffer used may be selected based on the type of file being accessed. Other features may be included as well based on individual implementations.

### BRIEF DESCRIPTION OF THE DRAWINGS

FIG. 1 illustrates a system for integrating a plurality of cloud storages.

FIG. 2 illustrates an embodiment of the integration system of FIG. 1 for integrating a plurality of cloud storages.

FIG. 3 shows an alternative embodiment of a system for integrating a plurality of cloud storages.

FIG. 4 shows a method for storing data on a plurality of cloud storages.

FIG. 5 shows a method for retrieving data stored using the method of FIG. 4.

FIG. 6 shows a method for retrieving chunks of data stored using the method of FIG. 4 for immediate playback.

FIG. 7 shows a method for recording and tracking the locations of chunks of data stored using the method of FIG. 4, and for moving chunks of data between storages.

FIG. 8 provides a block diagram illustrating the relationship between components of the system of FIG. 3.

FIG. 9 is a drawing of an exemplary user interface associated with the system of FIG. 3.

FIGS. 10A-J are drawings of various displays from a second exemplary user interface associated with the system of FIG. 3.

### DETAILED DESCRIPTION OF THE PREFERRED EMBODIMENTS

The description of illustrative embodiments according to principles of the present invention is intended to be read in connection with the accompanying drawings, which are to be considered part of the entire written description.

The features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

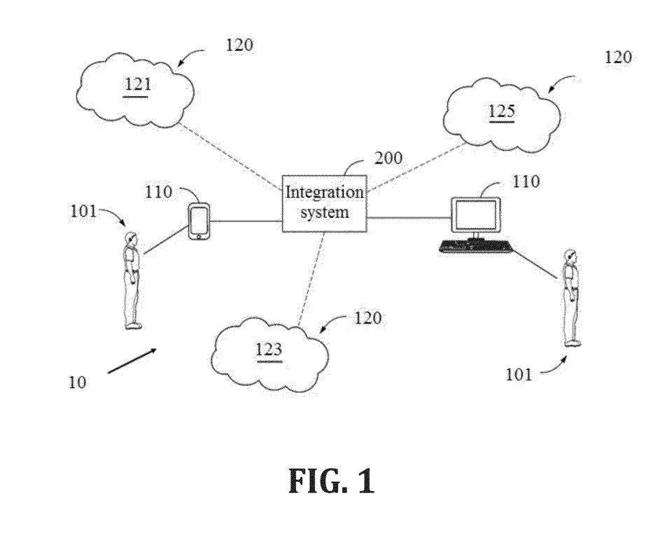

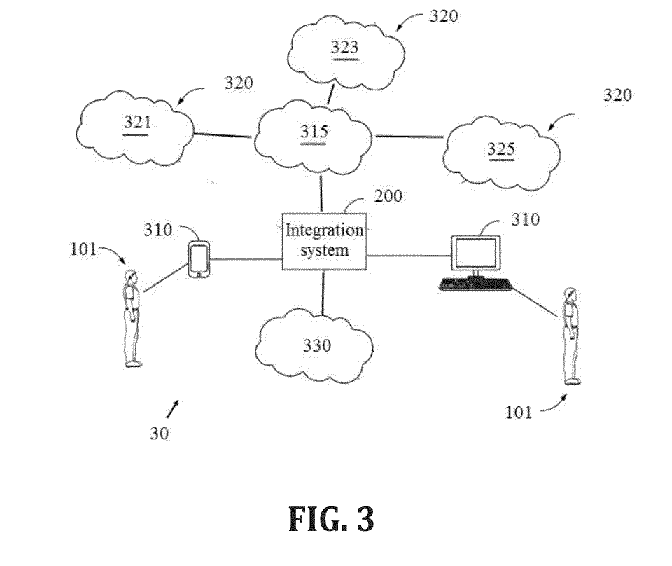

FIG. 1 illustrates a system 10 for integrating a plurality of cloud storages 120. System 10 includes devices 110 which communicate through integration system 200 to cloud storages 121, 123, 125 (referred to herein collectively as cloud storages 120). Each user 101 may control integration system 200 via a device 110 for integrating and managing multiple cloud storages 120. Although this particular implementation of system 10 for integrating a plurality of cloud storages 120, along with an alternate implementation described with respect to FIG. 3 as system 30, is illustrated and primarily described, the present disclosure contemplates any suitable network implementation of system 10 for integrating a plurality of cloud storages 120, or any of its components, according to particular needs of the institution or facility. Further, the present disclosure contemplates the substitution of a variety of remote storages in place of cloud storages 120 such that the features described below in relation to cloud storages may be implemented, instead, using servers located on a local area network or to a data center set up in various configurations.

Further, although three cloud storages 120 are illustrated and described, it is envisioned that one, two, or any number of cloud storage accounts 120 may be implemented by system 10.

Continuing with reference to FIG. 1, users 101 may be individuals that own cloud storages 120 or otherwise have access to the cloud storages 120. Devices 110 may be any device that is capable of receiving input data from users 101 and transmitting the data to integration system 200. For example and without limitation, device 110 may be a desktop computer, laptop computer, tablet device, mobile device such as a cellular phone, or any other device suitable for, and capable of, transmitting data between devices 110, integration system 200, and cloud storages 120.

Although system 200 and device 110 are shown and described as two separate components, in some embodiments system 200 and device 110 are a single device. For example and without limitation, in particular embodiments, device 110 includes all of the hardware, software, and executable instructions necessary to process the methods described herein for storing and processing data in cloud storages 120 or other hardware.

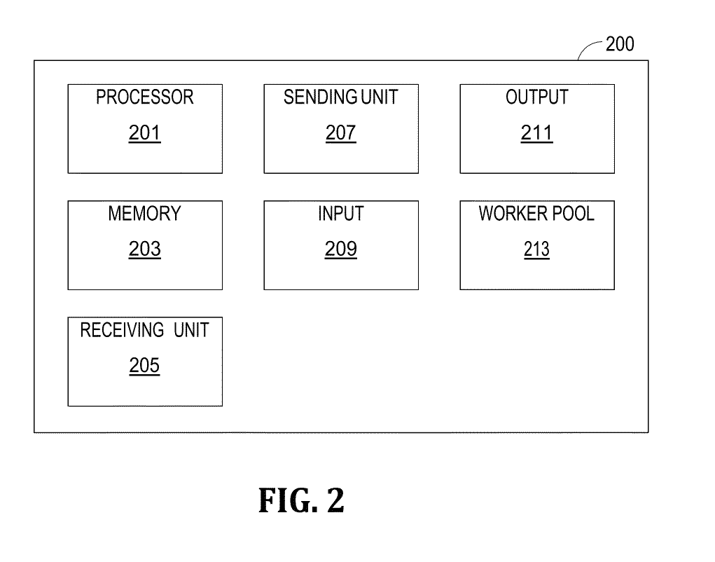

FIG. 2 illustrates an embodiment of integration system 200 of system 10 for integrating a plurality of cloud storages 120. As shown, the integration system 200 may include a central processing unit 201, a storage unit, memory and/or database 203, a receiving unit 205, a sending unit 207, input 209, output 211, as well as a worker pool 213 for maintaining a pool of workers. Input 209 may be any suitable form of data input such as and without limitation a keyboard and/or touch screen. Output 211 may be any suitable output such as and without limitation a display, monitor, output unit, and/or touch screen. Various functions, such as display and input functions may instead be performed on a user device 110 utilizing hardware components associated with that device.

The receiving unit 205 may be configured to receive user data, such as user login and authentication information for a user account within integration system 200 and/or login and authentication information for cloud storages 120. In particular, the receiving unit 205 may receive information or data, such as and without limitation, data associated with the username and password for the user account and a plurality of cloud storages 120.

Additionally, the receiving unit 205 may be configured to receive authentication tokens from cloud storages 120 for storage in memory 203. Additionally, receiving unit 205 may also be configured to receive files, folders, and/or data associated with files and/or folders which may be stored locally on memory 203 or within one of the cloud storages 120. Additionally, receiving unit 205 may be configured to receive files and/or data associated with cloud resources, which may be data related to files or folders stored on one or more cloud storages 120. In some embodiments, receiving unit 205 is configured to determine the type of file or data received. In particular, receiving unit 205 is configured to determine if such a cloud resource represents a file folder, a music file, document file, video file, audio file, partitioned file, metadata, etc.

As used herein, the term cloud resource may be understood to refer to data maintained as a unit using the system 10 of the present disclosure. The cloud resource may contain references to information stored in various locations, and may be treated as a pointer or collection of pointers, and may include information stored within integration unit 200 or information stored within the plurality of cloud storages 120. The information may relate to files stored on the plurality of cloud storages 120. For example, metadata, including one or more pointers, and an index of cloud storage locations may comprise the cloud resource and may be stored in integration unit 200 while additional chunks of data comprising a file referenced by the cloud resource may be stored on one or more cloud storages 120. In some embodiments, when a file is received by the receiving unit 205, the integration unit 200 processes the file to create a cloud resource, which then contains any metadata associated with the file and instructions or other information for retrieving the file.

Generally, when a cloud resource is created, it may be provided with a file type identification, and may be treated as a file in and of itself within the platform discussed herein, as well as compatible platforms. Accordingly, a cloud resource may be transmitted between users by email or other messaging platforms. The cloud resource may comprise pointers or other identifications of storage locations of one or more chunks of a file associated with the cloud resource. The cloud resource may further comprise additional metadata related to a file associated with the cloud resource, such as the metadata from the file itself, and may further comprise passwords and other data required for decrypting the chunks of the file and the file itself.

A cloud resource, the creation of which is described at length below, may then be used in a similar manner to the file associated with the cloud resource. A user may share a cloud resource with a second user, for example, and the two different users can then each access the file using the cloud resource. When the file is shared, it may be through the platform itself, an email platform, a calendar platform, a notes platform, a task platform, or other platforms, in the form of integrated or independent software applications, that may be compatible with the cloud resource.

Once a user receives a cloud resource at a user device, it may be stored on the user device, or it may be stored on a cloud platform within an account associated with the user. It may then be loaded into the user's local memory from a corresponding database associated with the integration system 200 for quick access to the cloud resource, and any file associated with the cloud resource. When disconnected from the internet, the user's local memory may retain a copy of the cloud resource and/or the relevant portion of the database. As such, the user device on which the cloud resource is accessed may always have a copy of the data available, even while the data is being updated in the background.

When the user receiving the cloud resource accesses the cloud resource, they are connected to the file associated with the cloud resource in much the same way as they would be if they were the originator of the cloud resource. The user may then use this access to collaborate with other parties holding the same cloud resource. When multiple users collaborate using the cloud resource that is held each of the multiple users, a first user may open the file, as described below, and when a second user attempts to open the same file via the cloud resource, the platform may direct them to a buffer storage location where the first user has already reassembled and is accessing the file. The two users may then collaborate on a single file.

When a cloud resource may require updating, as described in more detail below, all copies of the cloud resource held by different users of the platform may be updated such that all copies continue to point to the appropriate locations for any associated files and chunks of files.

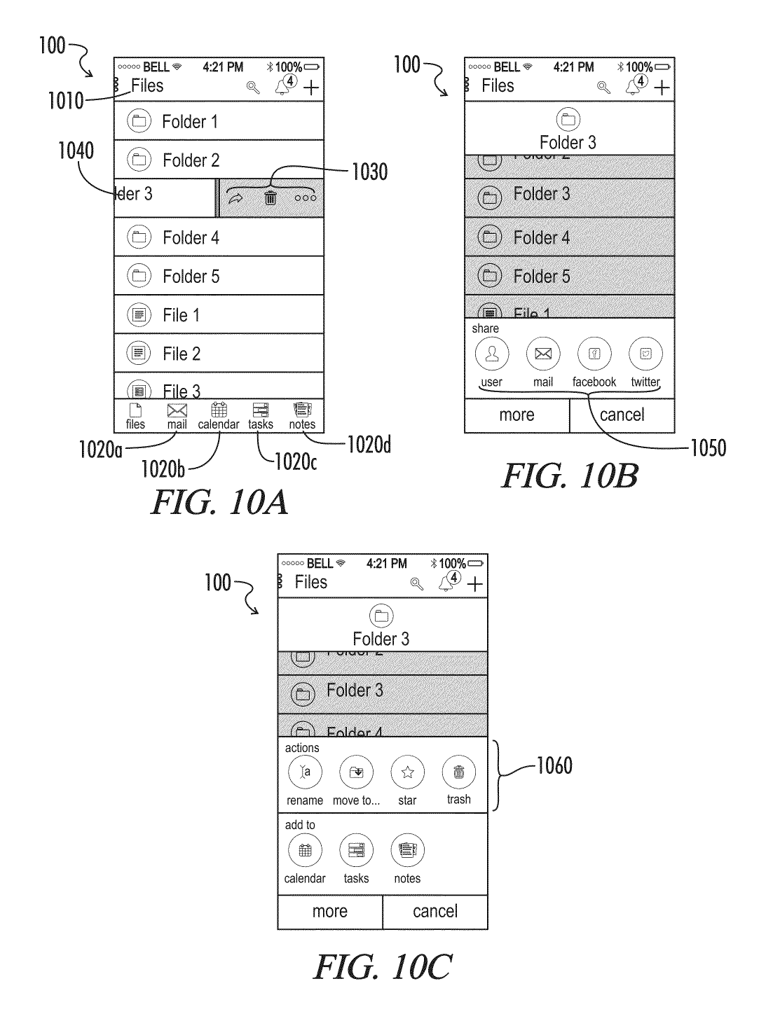

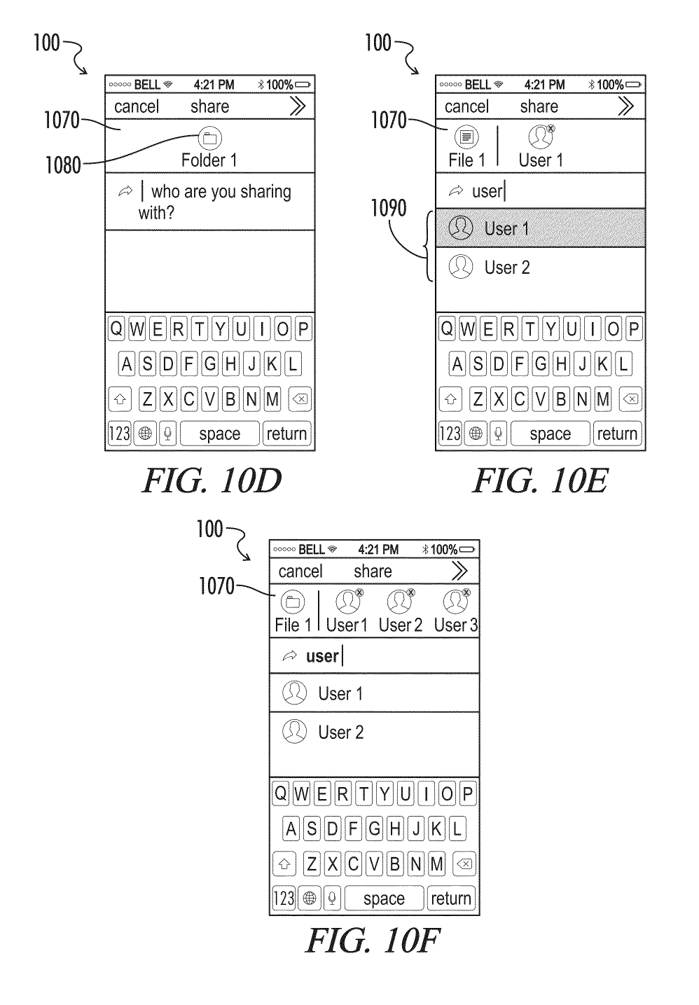

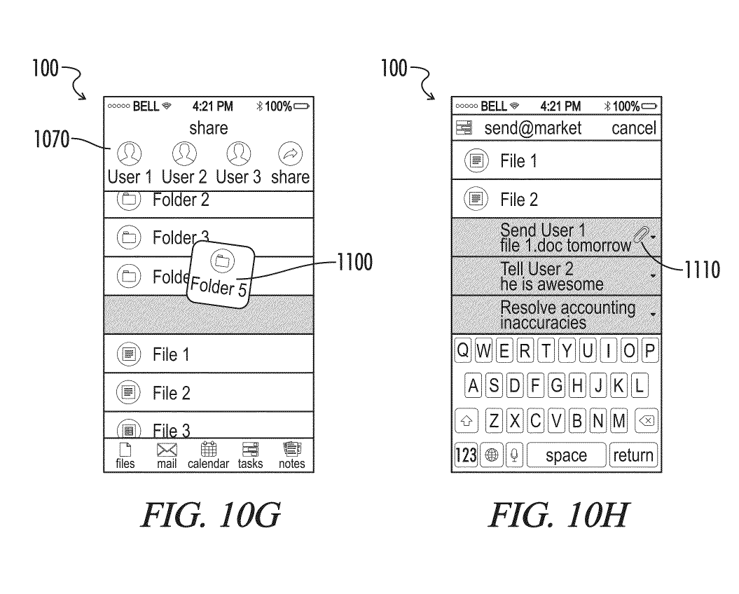

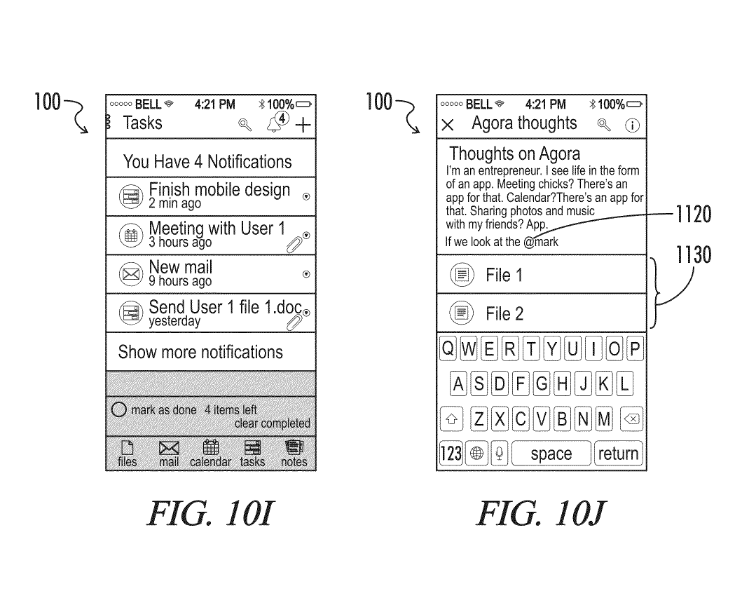

In some embodiments, where a first user sends a message to a second user containing a cloud resource, or a first user otherwise incorporates a cloud resource into a task list, calendar item, or other action item, the user may select a cloud resource to include by beginning a word with a reference character, such as @, at which point the system and method may provide a listing of available cloud resources for attachment to the action item. As a user types a file name, or otherwise applies additional descriptive information, the available files may be parsed by available cloud resources that continue to correspond to the description applied. For example, as a user types the first several letters of a file name, the user may only be shown files beginning with those several letters. This interface is illustrated in FIG. 10J.

As used herein, the term “file” may be understood to include, and is not limited to a file, data associated with a file, executable instructions, shortcuts or locations of a file or files, folders storing files, and any combination or variations thereof.

The integration system 200 may further contain a worker pool 213 comprising a plurality of workers that handle a variety of tasks associated with system 10.

The worker pool 213 is a virtual collection of workers, which are virtual machines waiting to accept a task from a queue received through receiving unit 205. When a message is received from a user 101 through a user device 110 at the receiving unit 205 it may be added to this queue and crawled to determine an appropriate message destination. Where necessary, the message may be directed to the worker pool 213 where an appropriate worker is identified and assigned a task identified based on the message. While workers may receive tasks from the queue, or from independent queues associated with each worker, certain tasks may be handled by workers in other ways. For example, some workers may perform tasks at regular intervals, rather than waiting to receive instructions. Workers in the worker pool 213 may be of different types and may be configured to handle different tasks. In the embodiments discussed, at least four types of workers are used.

Cloud access workers receive messages from a queue and perform tasks related to accessing the plurality of cloud storages 120 discussed. For example, when a user adds a cloud storage 121 to be accessed through integration system 200, the action sends a message to the queue. The cloud access workers then take the message from the queue and follow instructions associated with the task. The message may further include data required to complete the task. For example, accessing cloud storage 120 may require the use of a token, so the token required may be included in the message. Similarly, the cloud access workers may be used to access a file stored on one or more cloud storages 120 by retrieving tokens associated with the cloud storages, metadata for the file itself, such as in the form of a cloud resource, and using the token and metadata to retrieve data from the cloud storages. The cloud access worker may also be used to maintain the integrity of databases associated with system 10.

Cron job workers perform cron jobs, or scheduled tasks, required for maintenance of the system 10. Cron job workers perform scheduled tasks, and do not retrieve tasks from a queue. For example, cron job workers may be used to update data at regular intervals. When activated, the cron job worker may behave similarly to a cloud access worker, and may therefore be used to confirm the accuracy of databases or update database on an ongoing basis.

Email sender workers are used to process messages from a queue of messages from email submissions and transmissions. Typically, this queue is generated when emails or email attachment requests are generated by users 101 utilizing the system from a front end accessed at a user device 110, which is then sent to the integration system 200, which in turn forwards to the queue. The workers may be used to retrieve and attach files to outgoing messages or otherwise retrieve messages through an email protocol. Messages in the queue may have details of the email (from, to, body, one or more attachments, etc.) as well as an identification of one or more cloud resources stored within system 10. Messages in the queue may further contain a cloud resource. The identification of the cloud resource, or the cloud resource itself, may be contained in, or comprise, the attachments. The email sender worker may then look up the cloud resource identified, retrieve a file associated with the cloud resource, attach the file to the message, and then send the email message, or instructions to send the email message to an appropriate location. In some email system, it may send a request to the email SMTP server to send the message.

Partitioning workers may determine whether a file should be partitioned, and may then perform a variety of tasks discussed in this application, including encrypting and partitioning files compiling metadata required to generate a cloud resource associated with a file, and storing chunks of data in the cloud storages 120. The partitioning workers may further process the reassembly of partitioned files, and maintain communications with a resource indexer, both described in more detail below.

It will be understood that the variety of workers discussed here is not limiting, nor are the tasks assigned to each worker type exclusive. The discussion provided is merely to aid in the understanding of other parts of this application in which workers are utilized.

FIG. 3 shows a second embodiment of a system 30 for integrating a plurality of cloud storages 320. System 30 includes devices 310 which communicate through integration system 200 with a buffer storage 315 which in turn connects to a plurality of cloud storages 321, 323, 325 (referred to herein collectively as cloud storages 320). Each user 101 may control integration system 200 via a device 310 for integrating and managing multiple cloud storages 320. The buffer storage 315 may be a cloud storage, and in some embodiments, it may be one of cloud storages 320. The buffer storage 315 may be selected from cloud storages 320 in order to process a specific command submitted to integration system 200, or to be compatible with a specific file type being processed by the integration system.

The system 30 may further contain an independent resource indexer 330 for indexing the location of data within the system. The resource indexer 330 may maintain a database of all files being managed by integration system 200 and may index all partitioned components or chunks within the system. The resource indexer 330 may be a database stored in memory 203 of the integration system 200, on user device 310, or in a cloud storage 320. In some embodiments, the resource indexer 330 tracks or maintains a database of cloud resources, which in turn contain references to files.

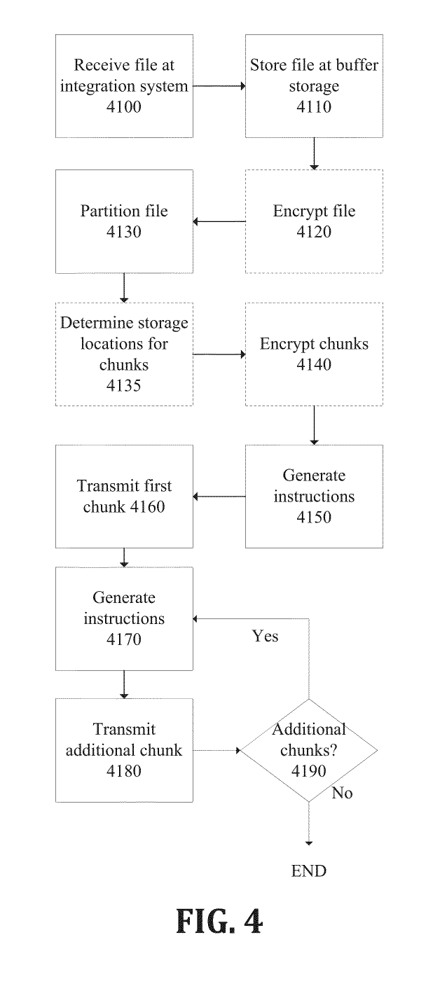

FIGS. 4-7 show and describe methods of the current invention in particular detail. Although the methods are shown in the figures and described herein as including particular steps, it is appreciated that some of the steps of the methods may be option or otherwise not required to perform the methods. Although described in a particular order, the methods described herein may be carried out in any order not explicitly described herein.

FIG. 4 shows a method 400 for storing data on a plurality of cloud storages 320. Method 400 begins with the system 30 receiving (4100) a file at integration system 200. Where this disclosure references a file, it will be understood that the method and system may be applied to other data storage formats as well, such as a file folder. The file may be received (4100) from a user 101 previously registered with the integration system 200. The integration system 200 then stores (4110) the file at the buffer storage 315 to facilitate further processing. While the buffer storage 315 is generally a cloud service, in some embodiments, the memory 203 internal to the integration system 200 or memory on a user device 310 may be used as the buffer storage 315. Alternatively, a user's local network may be configured to act as both integration system 200 and buffer 315 for processing and storing files in cloud storages 320.

Optionally, the integration system encrypts (4120) the file in the buffer storage 315 prior to further processing. This step may take place prior to storing the file in the buffer storage 315 as it passes through the integration system, such that the unencrypted file is never placed in a cloud service, or after initially storing the file in the buffer storage. The encryption may be, for example, RSA. In some embodiments, metadata is extracted from the file in advance, and is transmitted to the resource indexer 330 for use in a cloud resource associated with the file.

The integration system 200 then partitions the data file into a plurality of chunks of data (4130) to be stored independently. In some embodiments, partitioning is performed by partitioning workers from the worker pool 213 of integration system 200. Accordingly, the integration system 200 may deploy partitioning workers as needed, allowing the method and system to be scaled in real-time and address unexpected volume.

Optionally, the integration system 200 then determines the storage location 4135 to be utilized for each chunk of data. In such an embodiment, the integration system 200 may then embed storage information in the chunks of data before storing them. The storage information may be configured to support the retrieval and reassembly of the chunks. For example, each chunk may be embedded with the storage location of the next chunk to be retrieved. Alternatively, or in addition, each chunk may be embedded with data necessary to decrypt the following chunk of data, such as a private RSA key.

Optionally, the integration system 200 then encrypts (4140) each chunk of data independently of other chunks. The encryption may be using a method similar to that applied in step 4120 to the file itself, or it may be a different encryption method. Similarly, it may use similar or distinct encryption keys. Further, different chunks of data, or groupings of chunks of data, may be similarly encrypted with different methods or using different keys. In some embodiments, each chunk is encrypted with its own public RSA key and the file is encrypted with a master public RSA key. Each chunk may then hold its own public RSA key and the master public RSA key may be appended to the end of one of the chunks of data.

The integration system 200 then generates (4150) a first set of instructions compatible with the a first cloud storage 321 for storing the first chunk of data, and transmits (4160) the first chunk of data from the buffer storage 315 to the first cloud storage along with the compatible instructions for storing the first chunk of data on the first cloud storage. The first set of instructions includes instructions for storing and, in some embodiments, future processing of the first chunk of data.

The integration system 200 then generates (4170) a second set of instructions compatible with a second cloud storage 323 different than the first set of instructions and transmits (4180) a second chunk of data from the buffer storage 315 to the second cloud storage along with the compatible instructions for storing the second chunk of data on the second cloud storage. The second set of instructions includes instructions for storing and, in some embodiments, future processing of the second chunk of data.

As discussed below, when each chunk is transmitted to a cloud storage 320 for storage, the integration system 200 may receive from the cloud storage in response a value representing the storage location of the chunk. This may then be transmitted to the resource indexer 330 for integration into a corresponding cloud resource.

The integration system 200 then checks (4190) the buffer storage 315 to determine if additional chunks of data are to be stored. If such chunks exist, the integration system will repeat steps 4170 and 4180 for each additional chunk, with each chunk being sent to a cloud storage 320 along with instructions generated to be compatible with that particular storage system.

In embodiments where the buffer storage 315 is a cloud storage service, the buffer storage may be used as one of the cloud storages 320 on which data is stored. The complete file will be deleted from the buffer storage 315 once the file has been partitioned and stored. In some embodiments, each chunk is deleted from buffer storage 315 once it is transmitted to a cloud storage system 320.

In some embodiments, prior to transmitting chunks of data to various cloud storages 320, the integration system 200 stores metadata relating to the file as well as indexed locations of a first chunk, or several chunks, of the file in the resource indexer 330, described in more detail below. The resource indexer may then contain metadata stored in a specialized format that can be accessed and utilized without determining the storage location of the file and without retrieving the file. The metadata stored in this manner is referred to as a cloud resource. In some embodiments, each chunk is embedded with the storage location of the following chunk of data. In such embodiments, the cloud resource may include the storage location of the first chunk to begin the process of retrieving the file.

In some embodiments, each chunk is stored in two or more different cloud storage systems 320 in order to ensure redundant storage. Accordingly, the storage may use, for example, a RAID storage scheme.

The chunks of data may each be the same size, or they may be different sizes. In some embodiments, after encrypting the file, the file is partitioned into N different chunks, each at a different “chunk breakup multiple,” each of which will also be encrypted. The chunk size may be randomized to increase security.

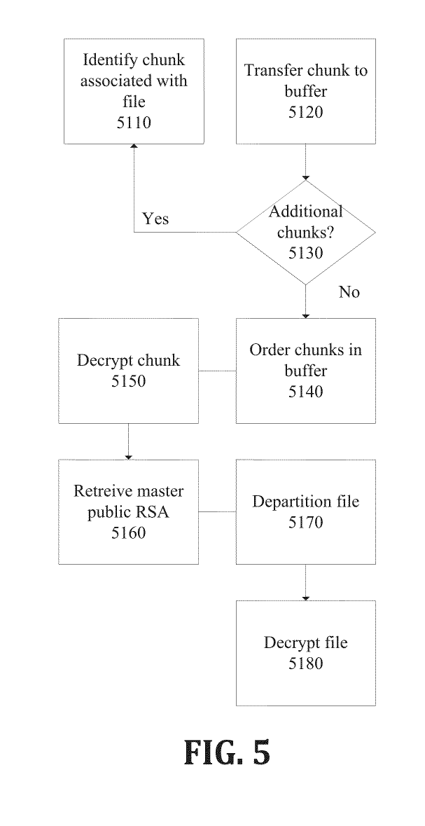

FIG. 5 shows a method for retrieving the data stored in the method of FIG. 4. Where the file is encrypted and where each chunk is encrypted, both using RSA, the method 500 for retrieving a file requires first identifying (5110) the location of a chunk associated with the file. In some embodiments, this is done by accessing the cloud resource, which may contain the storage location of the first chunk of data. The integration system 200 then transfers (5120) the chunk to the buffer storage 315, and determines (5130) if additional chunks remain. Information about additional chunks, including the storage location of one or more additional chunks, may be embedded in the first chunk. The integration system 200 then repeats the cycle until all chunks have been transferred to the buffer storage 315, by utilizing the information in the cloud resource or previously retrieved chunk to identify a new chunk associated with the file (5110) and transferring that chunk to the buffer.

The retrieval of the chunks, as well as any required information about the chunks required for ordering the chunks for reassembly, may be supported by a database maintained by the resource indexer 330, which is described in more detail below. Once collected, the integration system 200 orders (5140) the chunks with respect to each other, and any additional relationships between chunks are identified to determine appropriate break points in the file.

Once all chunks are ordered and any necessary information related to chunk size of each chunk is identified, each chunk is then decrypted (5150) using the public RSA key provided with the chunk. The master public RSA key is then retrieved (5160) from the end of the first chunk of the file, and the file parts are de-partitioned (5170). In some embodiments, each chunk is decrypted as soon as it is retrieved in order to provide embedded data related to the storage location of the next chunk. Similarly, in some embodiments, each chunk contains information, such as a public or private RSA key, required for decrypting the following chunk.

Finally, the file itself is decrypted (5180) using the RSA public key retrieved from the end of the first chunk of the file.

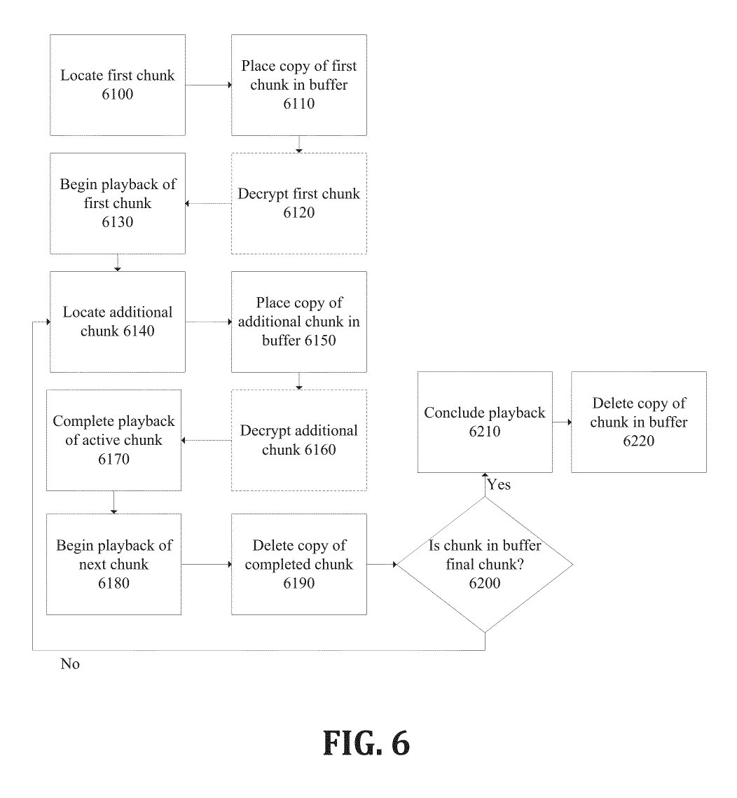

FIG. 6 shows a method for retrieving chunks of data stored using the method of FIG. 4 for immediate playback. In the embodiment shown, the file was not encrypted prior to partitioning. Accordingly, each chunk is encrypted using an RSA key and stored on a cloud storage system.

In the method 600 shown, playback is from the buffer storage 315. However, playback could be from any other storage system, including memory on a user device 110 or a local server. In some embodiments, the method first determines the file type of the file to be retrieved and played back, and appropriate storage to use as buffer storage 315 is selected for playback. For example, if the file is known to be a video file, a buffer storage 315 that can play the video back without accessing any external software may be selected.

In order to begin playback, the first chunk is located (6100) based on records in the resource indexer 330 and a copy of a first chunk of data is placed (6110) in the buffer storage 315. If necessary, the first chunk is then decrypted (6120), and playback begins (6130). Playback may be facilitated by an appropriate media player on the device 110 used to access the file, or it may be facilitated by a playback feature at the buffer storage 315, such as a playback feature integrated into a cloud storage system 320.

After beginning playback of the first chunk, a second chunk of data is located (6140), a copy is placed (6150) in the buffer storage 315, and decrypted (6160) if necessary. Upon completing playback (6170) of the portion of the data file contained in the first chunk, playback of the second chunk begins (6180). In some embodiments, the storage location of the second chunk of data is embedded within the first chunk, such that after the playback of the first chunk begins, the data from the first chunk is used to retrieve the second chunk.

After playback of the second chunk begins, the copy of the first chunk in the buffer storage 315 is deleted (6190), and the integration system 200 determines (6200) if the chunk being played is the final chunk. If additional chunks remain, the method returns to step 6140 and locates a third chunk for playback. The method continues to decrypt chunks, begin playback of the new chunk, delete chunks for which playback has been completed, and load new chunks so long as new chunks are available. When the final chunk is completed, the integration system 200 concludes playback of the file (6210) and the final chunk is deleted (6220) from the buffer storage 315.

In the method discussed, a single chunk is played back at a time, but it will be understood that multiple chunks may be transferred to buffer storage 315 simultaneously to reduce processing power required or to allow for encryption schematics for improving data security. For example, a single video file may be broken up into a set of X consecutive chunks, and each of those chunks may then be encrypted and further partitioned into Y smaller sub-chunks. The method of FIG. 6 may then be used to load all Y sub-chunks associated with the first of the X chunks, decrypt each sub-chunk and chunk, and then begin playback before loading the second of the X chunks. Each of the X chunks may then be readable, while each of the Y sub-chunks may be unreadable individually.

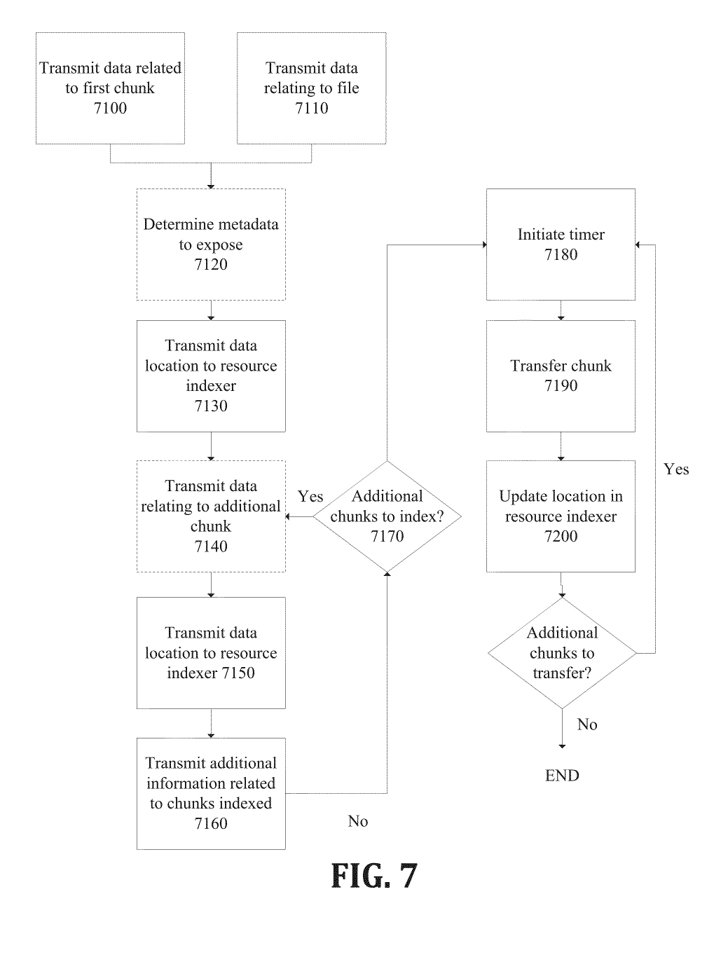

FIG. 7 shows a method for recording and tracking the locations of chunks of data stored using the method of FIG. 4, and for moving chunks of data between storages. The figure further shows how cloud resources are created in the resource indexer 330. In the method 700 shown, each chunk of data is stored in a cloud storage 320, and is indexed accordingly at resource indexer 330. Optionally, the chunks may then be moved between cloud storages at intervals in order to enhance security. Upon storage of a file, in some embodiments, the result of the process 700 is to create and maintain a database indicating the location for each chunk of data belonging to a file and to further maintain any necessary relationships and metadata associated with files, such that the files can be reconstituted from the chunks using the data stored in the database. In other embodiments, only metadata related to the file and details for the retrieval of the first chunk are stored in the resource indexer, and that data is used to retrieve the first chunk. Data embedded within the first chunk may then be used to retrieve additional chunks. In yet other embodiments, the references to the various chunks in either the cloud resource or other chunks act as pointers to the chunk requested. In such a scenario, the pointers may be stored in the cloud resource, but the location of storage within the cloud resource may be contained in a previous chunk. For example, when a first chunk is retrieved based on the pointer in the cloud resource, the chunk may be decrypted to determine the location of the pointer to storage location of a second chunk within the cloud resource. As such, the pointer may be consistently updated within the cloud resource, but the proper sequence of pointers may only be available by retrieving and decrypting the previous chunks.

Accordingly, in the context of method 400, when the integration system 200 transmits (4160) the first chunk of data from the buffer storage 315 to the first cloud storage, the integration system 200 may also transmits (7100) data related to the first chunk of data, such as the file metadata, to the resource indexer 330.

In the alternative, prior to, or instead of, transmitting data relating to the first chunk of data, the integration system 200 may transmit (7110) data relating to the file, including the file metadata, and may then associate data received relating to the chunks with the record of the file for indexing purposes. For example, the integration system 200 may receive in response to the storage of each chunk, from the first cloud storage for that chunk, a value representing the location of the corresponding chunk of data. That value may then be indexed accordingly by, for example, integrating it into the cloud resource.

In some embodiments, any metadata related to the file is stored in the resource indexer 330, and the chunks of data may not have any metadata attached to them when they are transmitted to the cloud storages 320. In such embodiments, metadata for a file, or a chunk of data stored, is made available to cloud storages 320 as well as users 101 and user applications through the resource indexer 330 in the form of a cloud resource. Further in some embodiments, only a limited amount of the total metadata for each file is made available.

Accordingly, each file may have a set of applied metadata that is a subset of the file's general metadata, and the applied metadata is the only metadata available while stored in the resource indexer. In such an embodiment, the integration system 200 may determine (7120) what metadata to expose as applied metadata. The applied metadata is selected based on the cloud storage systems to which the integration system 200 has access. Accordingly, the applied metadata available for any given file will contain any fields utilized by the cloud storage systems accessed by the integration system 200 for that file. The applied metadata may then be utilized as the metadata for the cloud resource.

The integration system 200 then transmits (7130) data related to the storage location of the first chunk of data to the resource indexer 330.

After transmitting (4180) the second chunk of data from the buffer storage 315 to the second cloud storage, the integration system 200 optionally transmits (7140) data related to the second chunk of data, in embodiments in which data related to individual chunks is transmitted, and further transmits (7150) data related to the storage location of the second chunk of data required by the system to the resource indexer 330. This data transmitted includes the equivalent data to that transmitted for the first chunk.

In some embodiments, the integration system 200 first transmits (4160) the first chunk to the first cloud storage, and the first cloud storage transmits a value representing the storage location of the first chunk in response. The value may then represent the data location transmitted (7150) from the integration system 200 to the resource indexer 330.

Accordingly, where the metadata for the file was transmitted 7120, only a storage location may be required with respect to the second chunk of data. In transmitting information about the various chunks, the resource indexer may further transmit (7160) information related to partition locations within files, size of individual chunks, public and private RSA keys for individual chunks, ordering information, and relationships between chunks.

The integration system 200 will then check for additional chunks (7170) and repeat the storage recordation process for any remaining chunks.

In some embodiments, the integration system 200 may move chunks between cloud storages for security purposes at intervals. In such embodiments, the integration system 200 may initiate a timer (7180) until the next move time. The timer will then be continuously queried (7190) until the move time is reached or the appropriate time interval has elapsed. At the move time, the integration system 200 transfers (7190) the first chunk from the first cloud storage 321 to a different destination cloud storage 320. Accordingly, the integration system 200 generates and transmits instructions for transmitting the file compatible with the first cloud storage and instructions compatible with the destination cloud storage in order to store the file in a new location.

The destination cloud storage 320 may be the second cloud storage 323 or another cloud storage. After the transfer, the integration system 200 retrieves information about the new storage location of the chunk and updates (7200) the resource indexer 330.

The integration system 200 then determines (7210) if additional chunks remain to be transferred and then repeats (7190) the transfer process for the second chunk and all remaining chunks, and updates (7200) the resource indexer 330 with the new locations of each chunk. In some embodiments, the destination cloud storage 320 for each chunk may be randomly or pseudo randomly selected.

Typically, instructions for various functions utilized by the integration system 200 may be generated by mapping or translating instructions utilized by a first system into instructions utilized by a second system. Accordingly, in one example, where the instruction to store a file in a first cloud storage 320 is “save,” the instructions to store a file in a second cloud storage is “store,” and the instruction used by the integration system 200 is “cache,” the integration system will receive the “cache” command, and it will then transmit chunks sent to the first cloud storage with the “save” command, and chunks sent to the second cloud storage with the “store” command. Similar commands may be mapped for any new cloud storage 320 added to the capabilities of the integration system 200. Mapping tables or other information required for mapping or translating commands may be stored in databases in the memory 203 unit, or they may be stored in a database located elsewhere.

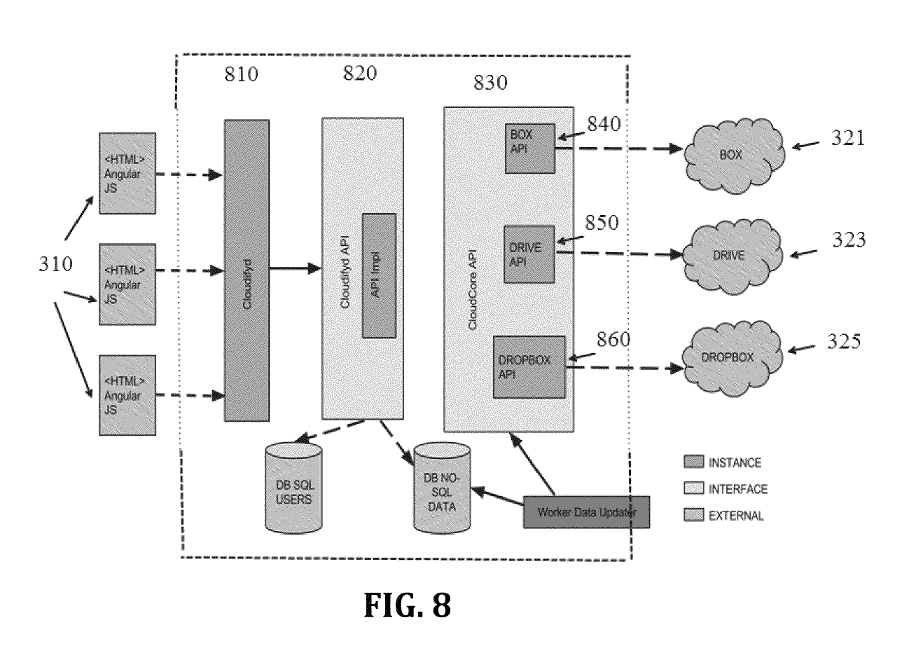

FIG. 8 provides a block diagram illustrating the relationship between components of the system 30 of FIG. 3. As shown in FIG. 3, the system 30 includes users accessing the system at devices 310. The devices 310 may access integration system 200 at a front end 810 utilizing, for example Angular JS. The devices 310 may also access integration system 200 sending RESTful API calls, such as in the case of mobile devices, for example.

The front end 810 is a user accessible interface for utilizing a system Application Programming Interface (API) 820 for communicating with the plurality of cloud storages 320. In some embodiments, the front end 810 may implement a RESTful API as well as a plurality of presentation layers. The system API 820 then transmits instructions to an instruction generation engine 830 which accepts instructions from the system API 820 and generates instructions compatible with third party APIs 840, 850, 860. Accordingly, a first third party API 840 may be compatible with a first cloud storage 321, a second third party API 850 may be compatible with s second cloud storage 323, etc.

Accordingly, in storing a file or a chunk of a file using the integration system 200, a user may input an instruction at a user device 310 utilizing the front end 810. The front end 810 then transmits that instruction to the system API 820 which determines the appropriate instructions to transmit to each associated cloud storage 320. The system API may then transmit an instruction ultimately directed at the first cloud storage 321 to the instruction generation engine 830 which in turn generates instructions compatible with the API for the first cloud storage 840 which is then transmitted to the first cloud storage.

The arrangement described allows for implementation of new cloud storage services, or other types of services by simply adding new APIs to the instruction generation engine 830. These services may be additional cloud services 320, simple SQL/non-SQL databases, distributed or local file systems, etc. This further allows the system API 820 to use identical instructions for storage regardless of the destination of a file or a file chunk.

The system API 820 may further allow for a plurality of new features that may be utilized through the front end 810. As one example, users may be able to reorganize their files across multiple cloud storages 320 in a single interface supported by the front end 810. Multiple file structures from a plurality of cloud storages 320 may then be combined and presented to a user 101 at a user device 310 as a single file structure.

Alternatively, a user 101 may be able to utilize the front end 810 to transfer a file from a first cloud storage 321 to a second cloud storage 323. The front end may then instruct the system API 820 to retrieve the requested file from the first cloud storage 321 and upload the requested file to the second cloud storage 323, utilizing the instruction generation engine 830 to interface with the first cloud storage and the second cloud storage and facilitate a direct transfer, or a seamless transfer using a buffer storage 315.

In some embodiments, a user 101 may decide to transfer a file to a friend, but online of the cloud storages 320 may be capable of facilitating the transfer due to, for example, the friend only having an account with one of the cloud storage providers. In such an embodiment, the user may then utilize the front end 810 to retrieve the file from its storage location, or locations where the file is partitioned across multiple storages, upload the file to the appropriate cloud storage 320, transmit the file utilizing the appropriate API for that storage 840, 850, 860, and then return the file to its original storage location.

Similarly, where a user 101 wishes to playback a file partitioned across multiple cloud storages 320 without downloading the file, the user may utilize the front end 810 to select a cloud storage appropriate for playback of that file type, retrieve the chunks of the partitioned file utilizing the appropriate methods 500, 600 and playback the file.

In some embodiments, cloud resources in the resource indexer 330 may take the place of the data stored in the cloud storages 320. For example, in order to search data stored on a variety of cloud storages 320, a search engine may instead search metadata for those files in the resource indexer, stored in the form of cloud resources. Further, in order to present files maintained within the system, an API utilizing the system 30 may organize files in any number of ways. Because all cloud resources may be stored in a single location, and may be more easily accessed than the files themselves, an API may provide access to all cloud resources stored within the system, organized in folders and subfolders. When a user selects a cloud resource representing a file, the integration system 200 may then begin the process of retrieving and opening the specified file.

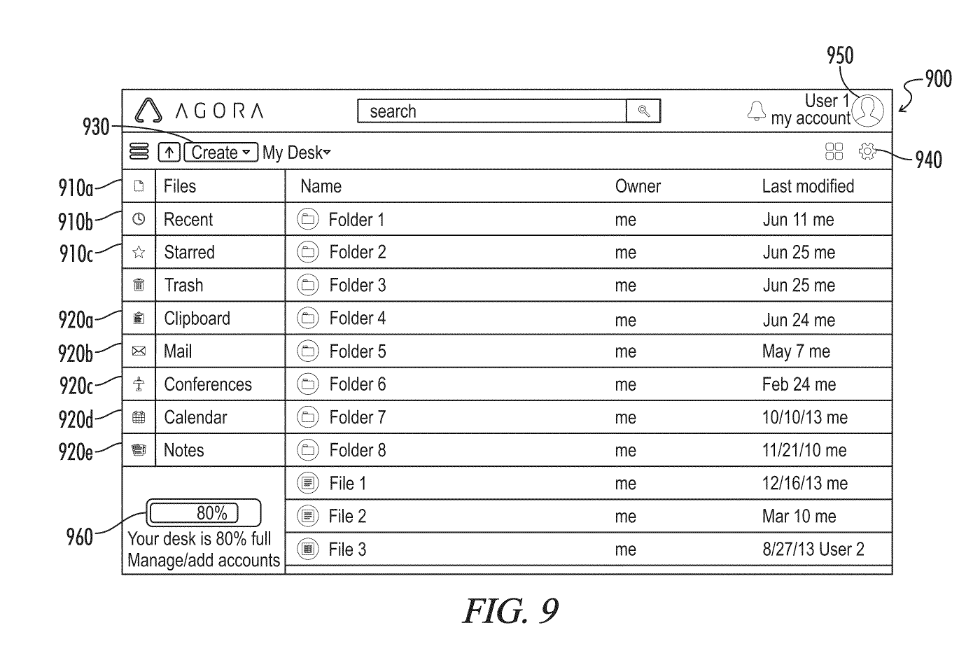

FIG. 9 is a drawing of an exemplary user interface 900 associated with the system of FIG. 3 when utilized in a web browser or similar environment on a user device 310. In the user interface shown, users 101 may cause the integration system 200 to move files between folders, where each file or folder may be stored across multiple storages 320.

It will be understood that files and cloud resources associated with those files accessed within the user interface 900 may be moved superficially only within the interface, or may be moved within the back end storage platform as described above. Typically, a file moved within the interface will move only within the interface, as the folders shown in the interface may exist only within the interface (and not within the cloud storages) and they may exist only for storage of cloud resources (and not for storage of the files corresponding to those cloud resources). However, in some embodiments or scenarios, a move of a cloud resource within in user interface 900 may trigger a corresponding move of files in the cloud storages.

The user interface 900 may include buttons for accessing specific features discussed herein, including different organizational schemes for files 910a-c, such as a general listing of files and folders 910a, a listing of recently viewed files or folders 910b, and a listing of “starred” or otherwise highlighted files or folders 910c. The user 900 interface may further include buttons 920a-e for accessing file sharing and other features, including a clipboard 920a where files or cloud resources can be stored when moving between different locations, email 920b, conferences 920c for collaborating with other users, calendars 920d where cloud resources may be included in calendar events for easy access, and notes 920e. Dropdown menus 930 may provide access to additional features, as do further organizational tools 940 (providing access to settings, additional views, etc.). A link 950 is provided for accessing user profile information as well. Additional information may be provided as part of the display, such as an indication of the percentage of account accessible memory is currently full 960.

FIGS. 10A-J shows various screens from a user interface 1000 illustrating various features associated with the platform of FIG. 3 when accessed from a mobile user device 310. As shown in FIG. 10A, a listing of files and folders may be provided in a main display page when accessed by selecting a “files” button 1010. Access may be further provided to various specific features discussed herein, including mail 1020a, calendar 1020b, tasks 1020c, notes 1020d. Although the features are not identical, and the user interface differs, these features, along with other features not labeled, may correspond generally to those shown in FIG. 9. When utilizing the user interface 1000, a user may access features 1030 associated with a specific file or folder by swiping a listing 1040 associated with that file or folder horizontally.

As shown in FIG. 10B a user may share a file or folder within the interface (typically in the form of a cloud resource, as discussed above) by posting it to various social media platforms, by selecting those platforms 1050. Similarly, users may select other targets for sharing, such as using an Email application or by sharing with a specified user. As shown in FIG. 10C, additional features 1060 associated with the user interface 1000 may be accessible as well. These features 1060 may correspond to features shown in the user interface 900 that are typically hidden in order to conserve screen real estate.

As shown in FIG. 10D-G, a set of screen from the interface 1000 may be associated with sharing a file or folder with one or more users. Shown across a top bar 1070 initially is a file or folder 1080 to be shared with third party users. The interface 1000 may then be used to begin typing a name in order to identify third party users with whom to share the file or folder 1080. Users may then be identified by the interface 1000 for potential inclusion in a distribution of the file or folder 1080, or a cloud resource associated therewith, and may be listed 1090 for selection. When users are selected, they may then be moved to the top bar 1070 to indicate selection.

As shown in FIG. 10F, multiple users may be added in this manner to the top bar 1070 as targets for distribution. As shown in FIG. 10G, files or folders may be added for distribution after the users are selected as targets for distribution. Files or folders 1100 may be selected from a listing and dragged and dropped to a portion of the display associated with such distribution.

As shown in FIG. 10H a task list may be provided with access to files 1110. In such an embodiment, the access to files may be by including a cloud resource associated with the file in the task item within the task list. Similarly, files may be incorporated into tasks and reminders in other parts of the interface 1000, as shown in the notification listing within the task list of FIG. 10I.

As shown in FIG. 10J, an email or other message may be written and may include, as an attachment, a cloud resource associated with a file. In inserting the cloud resource into the message, a user may begin typing a name of a file, preceded by an @ symbol 1120. As shown, the interface 1000 may then provide a listing 1130 of available files or folders with associated cloud resources which may be included in the message through such a selection.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” and like terms encompass all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A computer based method for storing data comprising
splitting a file into a plurality of chunks;
sending a first chunk to a first storage with a first instruction particular to the first storage;
sending a second chunk to a second storage with a second instruction particular to the second storage;
wherein the first instruction is different than the second instruction.

2. The computer based method of claim 1 wherein the file is a file folder.

3. The computer based method of claim 1 wherein the first storage is a first cloud storage service and the second storage is a second cloud storage service.

4. The computer based method of claim 3 further comprising placing the file in a buffer storage prior to splitting the file into chunks, wherein the buffer is a third cloud storage service.

5. The computer based method of claim 1 further comprising encrypting the first chunk prior to sending it to the first storage and encrypting the second chunk prior to sending it to the second storage.

6. The computer based method of claim 5 further comprising encrypting the file prior to splitting the file into a plurality of chunks.

7. The computer based method of claim 1 wherein the first chunk and the second chunk contain different amounts of data.

8. The computer based method of claim 1 wherein an identification of the first storage collated with information about the first chunk and an identification of the second storage collated with information about the second chunk are recorded in an index.

9. The computer based method of claim 8 wherein metadata related to the file is stored in the index and the first chunk and the second chunk do not have associated metadata.

10. The computer based method of claim 9 wherein a search command initiates a search of the metadata in the index, returns search results related to files that have been split into a plurality of chunks and stored on a first storage and a second storage, and does not search the first storage or the second storage.

11. The computer based method of claim 8 further comprising:
sending a third instruction particular to the first storage to send the first chunk to one of a third storage or the second storage;
sending a fourth instruction particular to the second storage to send the second chunk to a fourth storage or the first storage; and
sending a fifth instruction to the index to replace the identification of the first storage with an identification of the third storage or the identification of the second storage and replace the identification of the second storage with an identification of the fourth storage or the identification of the first storage.

12. The computer based method of claim 11 wherein:
the third instruction includes a first portion particular to the first storage and a second portion particular to the third storage or the second storage and
the fourth instruction includes a first portion particular to the second storage and a second portion particular to the fourth storage or the first storage.

13. The computer based method of claim 1 further comprising:
placing a copy of the first chunk in a buffer storage and reading data contained in the first chunk;
placing a copy of the second chunk in the buffer storage after beginning to read the data contained in the first chunk to the user and reading data contained in the second chunk to the user after completing reading the data contained in the first chunk;
deleting the copy of the first chunk from the buffer prior to completing the reading of data contained in the second chunk to the user.

14. The computer based method of claim 1 wherein the file includes data corresponding to a type of file, and wherein the buffer is selected from a plurality of buffers based on the type of file.

15. The computer based method of claim 1 wherein the file contains applied metadata, and wherein applied metadata is a subset of the file metadata, only the applied metadata is accessible to the first storage and the second storage, the applied metadata is selected based on system requirements of the first storage and the second storage, the applied metadata is stored in an index, and wherein the chunks do not have associated metadata.

16. A computer system for storing data in a plurality of storages comprising:
an integration system, and
a buffer storage
wherein the integration system comprises:
a processor; and
a memory storing instructions executable by the processor to:
split files stored in the buffer storage into a plurality of chunks;
send a first chunk to a first storage with a first instruction particular to the first storage; and
send a second chunk to a second storage with a second instruction particular to the second storage,
wherein the first instruction is different than the second instruction.

17. The computer system of claim 16 further comprising an index, wherein the instructions are further executable by the processor to store an identification of the first storage collated with information about the first chunk and an identification of the second storage collated with information about the second chunk in the index.

18. The computer system of claim 17, wherein the instructions are further executable by the processor to send a third instruction to the first storage to send the first chunk to one of a third storage or the second storage, a fourth instruction to the second storage to send the second chunk to a fourth storage or the first storage, and a fifth instruction to the index to replace the identification of the first storage with an identification of the third storage or the identification of the second storage, and replace the identification of the second storage with an identification of the fourth storage or the identification of the first storage.

19. A method of accessing a file stored in a plurality of storages comprising:
determining a first storage location of a first chunk associated with the file;
placing a copy of the first chunk in a buffer storage and reading data contained in the first chunk;
determining a second storage location of a second chunk associated with the file;
placing a copy of the second chunk in the buffer storage after beginning to read the data contained in the first chunk to the user;
reading data contained in the second chunk after completing reading the data contained in the first chunk; and
deleting the copy of the first chunk from the buffer prior to completing the reading of data contained in the second chunk to the user;
wherein the first storage location is in a first storage and the second storage location is in a second storage.

20. The method of claim 19, wherein determining the second storage location is based on both data stored in an index and data stored in the first chunk.
